(19) United States
(12) Patent Application Publication
(10) Pub. No.: US 2009/0114676 A1
(43) Pub. Date: May 7, 2009

(54) Fuel dispensing apparatus having internal surface corrosion protection arrangement

(76) Inventors: Steven J. Showers, Greensboro, NC (US); Danny T. Lail, Winston-Salem, NC (US); Howard M. Myers, Greensboro, NC (US)

Correspondence Address: NELSON MULLINS RILEY & SCARBOROUGH, LLP, 1320 MAIN STREET, 17TH FLOOR, COLUMBIA, SC, 29201, US

(21) Appl. No.: 11/982,845

(22) Filed: Nov. 5, 2007

(51) Int. Cl. B67D 5/00; B67D 5/08; B67D 5/16; C23F 13/00; G01F 1/05

(52) U.S. Cl. 222/40; 204/157.15; 204/196.02; 222/63; 222/71; 73/861.79

(57) ABSTRACT

A fuel dispensing apparatus comprises a flow conduit defining a fluid flow path. A plurality of fuel handling components are connected along the flow conduit. The fuel handling components include a fluid meter to measure quantity of fuel being dispensed and at least one valve to vary flow of fuel through the flow conduit. In some embodiments, the fuel handling components to be protected may further include a shear valve. A corrosion protection arrangement is in electrical communication with at least one of the fuel handling components. The corrosion protection arrangement is operative to inhibit formation of corrosion at an internal protected portion of the fuel handling component due to electrical current passing through liquid therein. The corrosion protection arrangement may include a reference circuit providing a selected DC potential to the protected portion.

### BACKGROUND OF THE INVENTION

The present invention relates generally to fuel dispensing equipment. More particularly, the invention relates to fuel dispensing equipment having an arrangement for inhibiting internal corrosion of components through which the dispensed fuel flows.

Fuel dispensers are utilized to dispense fuel from an underground storage tank (UST) to a vehicle. A flow conduit in the dispenser is in fluid communication with the UST, typically via a shear valve located at ground level. Flow of the fuel through the conduit is regulated by a valve under the control of an on-board processor. A meter along the flow conduit is utilized to measure the quantity of fuel that is dispensed. The processor can determine and display the cost of the dispensed fuel based on the quantity. The fuel is delivered to the vehicle via a nozzle located at the distal end of a hose connected to the dispenser. Various details regarding the construction and operation of an exemplary fuel dispenser may be discerned from U.S. Pat. No. 6,935,191, incorporated herein by reference.

Fuel handling components along the flow conduit, such as the fluid meter, may be subject to internal corrosion due to chemical constituents or contaminants in the fuel. For example, the fuel will sometimes contain small quantities of water or certain chemical additives that can have a corrosive effect. Over time, this corrosion may impact the performance of the fuel handling component.

### SUMMARY OF THE INVENTION

According to one aspect, the present invention provides a fuel dispensing apparatus comprising a flow conduit defining a fluid flow path. A plurality of fuel handling components are connected along the flow conduit. The fuel handling components include a fluid meter to measure quantity of fuel being dispensed and at least one valve to vary flow of fuel through the flow conduit. In some embodiments, the fuel handling components to be protected may further include a shear valve.

A corrosion protection arrangement in electrical communication with at least one of the fuel handling components is also provided. The corrosion protection arrangement is operative to inhibit formation of corrosion at an internal protected portion of the fuel handling component due to electrical current passing through liquid therein. In this regard, the corrosion protection arrangement may include a reference circuit providing a selected DC potential to the protected portion.

The corrosion protection arrangement preferably impresses a relative negative potential in the range of approximately −0.3 to −0.7 volts between the protected portion and at least one other location along the fluid flow path. For example, positive terminals may be established at a first location upstream of the protected portion and a second location downstream of the protected portion. The protected portion may include at least one internal surface of a body of the fluid meter.

In some embodiments, a positive terminal may be established that is coaxial with the internal surface of the fluid meter body. If the fluid meter has a screw spindle, for example, the corrosion protection arrangement may impress the relative negative potential between the internal surface of the body and the spindle. In addition, or in the alternative, a positive terminal may be established at an inlet adapter of the fluid meter. A positive terminal may also be established at a pulser of the fluid meter.

Another aspect of the present invention provides a fluid meter comprising a body defining a fluid flow path. At least one spindle is located in the body along the fluid flow path, the spindle being adapted to rotate as fluid passes through the body. A pickup, such as a pulser, is operative to detect rotation of the spindle and generate a signal indicative of rotation. The meter further includes a corrosion protection arrangement in electrical communication with the body to impress a relative negative potential so as to inhibit formation of corrosion therein.

In some exemplary embodiments, the fluid meter further comprises an inlet adapter located at a first axial end of the body and electrically isolated therefrom. The corrosion protection arrangement in such embodiments may impress a relative positive potential at the inlet adapter. Alternatively, or in addition, a relative positive potential may be impressed at the pulser or the spindle.

A further aspect of the present invention provides a method of protecting from corrosion an internal portion of a fluid meter connected along a flow conduit. One step of the method involves providing a reference circuit adapted to produce a selected DC potential between first and second terminals. The first terminal is connected to a body of the fluid meter and the second terminal is connected to a second location electrically isolated therefrom. According to another step, liquid is caused to pass through the flow conduit. While the liquid is passing through the flow conduit, DC potential is impressed between the fluid meter body and the second location such that current flows through the liquid so as to provide cathodic corrosion protection at the internal portion to be protected.

Another aspect of the present invention provides an apparatus for dispensing a liquid. The apparatus comprises a flow conduit defining a fluid flow path for liquid. A plurality of liquid handling components are connected along the flow conduit. In addition, a corrosion protection arrangement is in electrical communication with at least one of the liquid handling components. The corrosion protection arrangement is operative to inhibit formation of corrosion at a protected portion internal to the liquid handling component due to electrical current passing through the liquid therein.

Other objects, features and aspects of the present invention are provided by various combinations and subcombinations of the disclosed elements, as well as methods of practicing same, which are discussed in greater detail below.

### BRIEF DESCRIPTION OF THE DRAWINGS

A full and enabling disclosure of the present invention, including the best mode thereof, to one of ordinary skill in the art, is set forth more particularly in the remainder of the specification, including reference to the accompanying drawings, in which:

FIG. 1 is a diagrammatic representation of a fuel dispenser in accordance with an embodiment of the present invention;

FIG. 2 is a diagrammatic representation of one implementation of a corrosion protection arrangement in accordance with an embodiment of the present invention;

FIG. 3 is a diagrammatic representation of a corrosion protection arrangement in accordance with an embodiment of the present utilized in conjunction with a twin spindle fluid meter;

FIG. 4 is a simplified schematic of a reference circuit that may be utilized in the embodiment of FIG. 3;

FIG. 5 is an exploded view of a fluid meter with which principles of the present invention may be employed;

FIG. 6 is an assembled perspective view of the fluid meter of FIG. 5 with a portion of the meter body cut away to show the screw spindles; and

FIG. 7 is a diagrammatic representation showing field pattern in an embodiment wherein the screw spindles are connected as positive terminals in the corrosion protection arrangement.

Repeat use of reference characters in the present specification and drawings is intended to represent same or analogous features or elements of the invention.

### DETAILED DESCRIPTION OF PREFERRED EMBODIMENTS

It is to be understood by one of ordinary skill in the art that the present discussion is a description of exemplary embodiments only, and is not intended as limiting the broader aspects of the present invention, which broader aspects are embodied in the exemplary constructions.

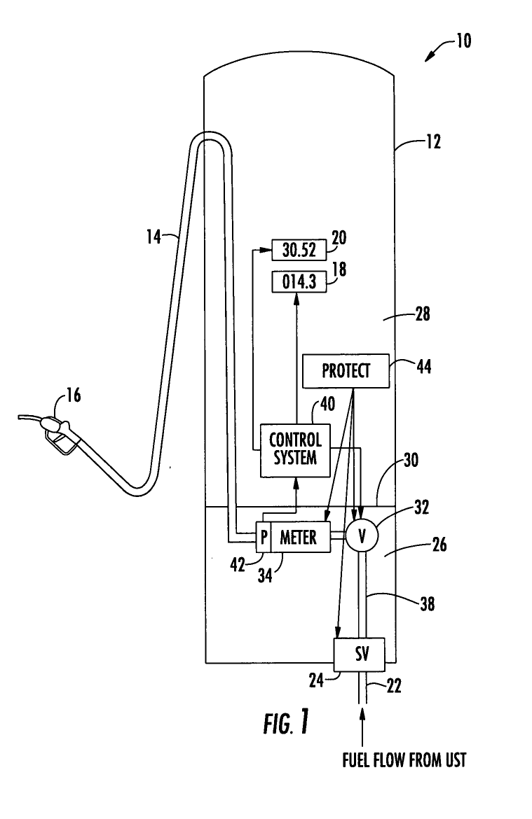

FIG. 1 illustrates a fuel dispenser 10 in accordance with an embodiment of the present invention. Fuel dispenser 10 includes a housing 12 with a hose 14 extending therefrom. A manually operated nozzle 16 is located at the distal end of hose 14. Nozzle 16 is inserted into the fill neck of a vehicle's fuel tank in a well known manner. Dispenser 10 thus allows fuel flowing from an underground storage tank (UST) to be dispensed to the vehicle's fuel tank. In this case, dispenser 10 includes a pair of displays 18 and 20 respectively indicating the quantity and price of fuel that has been dispensed. One skilled in the art will recognize that displays 18 and 20 may be light emitting diode (LED) displays, liquid crystal displays (LCDs) or any other suitable visual interface.

A flow conduit is located inside of housing 12 to provide fluid communication between the UST and hose 14. In this regard, fuel may travel from the UST via a fuel pipe 22, which may be a double-walled pipe. Fuel pipe 22 is connected to a shear valve (SV) 24 located at ground level. As is commonly known in the industry, shear valve 24 is designed to cut off fuel flowing through fuel pipe 22 if the fuel dispenser 10 is impacted. Generally, the fuel will be supplied using a submersible turbine pump (STP) associated with the UST. In some embodiments, however, the fuel may be drawn to dispenser 10 by a pump located within housing 12.

Housing 12 defines a fuel handling compartment 26 separated from an electronics compartment 28 by a vapor barrier 30. Various fuel handling components may be located in compartment 26, including valve (V) 32 and meter 34. As shown, valve 32 and meter 34 are located along the flow conduit 38 in the direction of the fuel flow path. In the illustrated embodiment, valve 32 is located upstream of meter 34, although embodiments are contemplated in which valve 32 may be located downstream of the meter. Valve 32 may be a proportional solenoid controlled valve.

Meter 34 communicates through vapor barrier 30 to a control system 40 located in electronics compartment 28. Control system 40 typically controls other aspects of the fuel dispenser 10, such as displays 18 and 20. In addition, control system 40 directs valve 32 to open and close when fuel dispensing is desired or not desired. If control system 40 directs valve 32 to open, this will permit fuel to flow through flow conduit 38. As a result, fuel will pass through meter 34 and eventually into hose 14. Meter 34 includes a pulser 42 which provides a signal to control system 40 indicative of the volumetric flow rate. The control system is thus able to update the information provided on displays 18 and 20. Meter 34 (including pulser 42) may in some cases be located in the column outside of the electronics cabinet.

As noted above, chemical constituents and contaminants in the fuel may sometimes cause corrosion to internal surfaces of the various fuel handling components. To inhibit such corrosion, fuel dispenser 10 includes a corrosion protection arrangement 44 in electrical communication with one or more of the fuel handling components. In this embodiment, for example, arrangement 44 has multiple channels in respective electrical communication with shear valve 24, valve 32 and meter 34. Arrangement 44 may have an additional channel to protect the STP.

In this regard, arrangement 44 impresses a DC potential between a protected portion of the fluid handling component and another location along the fluid flow path that is electrically isolated from the protected portion. As a result, current will flow through the liquid so as to provide cathodic corrosion protection. Other fluid handling components that could be protected include the manifold, nozzle, outlet castings and filters.

Referring now to FIG. 2, certain additional details of corrosion protection arrangement 44 may be explained in the context of inhibiting corrosion at meter 34. As can be seen, arrangement 44 includes a reference circuit 46 having respective positive and negative terminals 48 and 50. In this example, negative terminal 50 is in electrical communication with a body of meter 34. Positive terminal 48 is in electrical communication with a first location immediately upstream of meter 34 (at conduit section 38a) and a second location immediately downstream of meter 34 (at conduit section 38b).

Reference circuit 46 thus provides a relative negative potential between the body of meter 34 and the positive terminal locations. In particular, reference circuit 46 preferably provides a controlled voltage and current having values selected to yield the desired corrosion protection. Preferably, reference circuit 46 may have ammeter and voltmeter feedback circuits (either visible or computer output) for current and voltage monitoring. Electrical current passing through the liquid will inhibit the formation of corrosion at the protected surface.

The ideal voltage will often vary depending on the liquid being measured as well as materials of construction. For example, the negative potential may preferably fall in a range of approximately −0.3 to −0.7 volts in many embodiments of the present invention. A minimum current density of at least about 15 microamps per square centimeter has been found to be particularly desirable.

As shown, corrosion protection arrangement 44 further includes a suitable power source 52 to provide the requisite energy to circuit 46. Any suitable power source can be utilized, such as a chemical battery, solar cell, fuel cell, portable generator, sacrificial metal (i.e., magnesium, zinc) sources and commercial power. For example, power source 52 may be connected to commercial power with a battery backup to maintain corrosion protection in the event of a power failure. Preferably, an intrinsically safe barrier may be used to house the power leads and to power the circuit.

While protection arrangement 44 is shown in FIG. 1 as being located fuel handling compartment 26, one skilled in the art will appreciate that it may be located within electronic compartment 28. For example, the circuitry of arrangement 44 may be located alongside that of control system 40. In fact, control system 40 and protection arrangement 44 may share some common components.

FIG. 3 illustrates an alternative embodiment wherein the positive terminal of reference circuit 46 is connected to electrically isolated portions of the meter itself. In this case, meter 134 has a meter body 136 in which a pair of screw spindles is located. Various details regarding the construction and operation of a flow meter having interengaging screw spindles can be found in U.S. Pat. Nos. 6,250,151 and 5,447,062, both of which are incorporated herein by reference.

Conduit segment 38a is connected to an inlet adapter 140 immediately upstream of body 136. A pulser 142 is located immediately downstream of body 136. A discharge plate 144 and an outlet adapter 146 are located downstream of pulser 142, as shown. Conduit section 38b is connected to outlet adapter 146. Meter body 136 may be made, for example, of a corrosive material such as cast iron.

In this case, positive terminal 48 of reference circuit 46 is connected to inlet adapter 140 and pulser 142 immediately upstream and downstream of meter body 136, respectively. Inlet adapter 140 and pulser 142 are adapted to be electrically isolated from meter body 136. This may be accomplished in any suitable manner, such as using insulated paint or a dielectric film between the adjacent parts. As a result, electric current will travel through the fluid located inside of meter body 136 to protect it from corrosion. This embodiment is particularly desirable because the opposite polarity terminals are in relatively close proximity to one another.

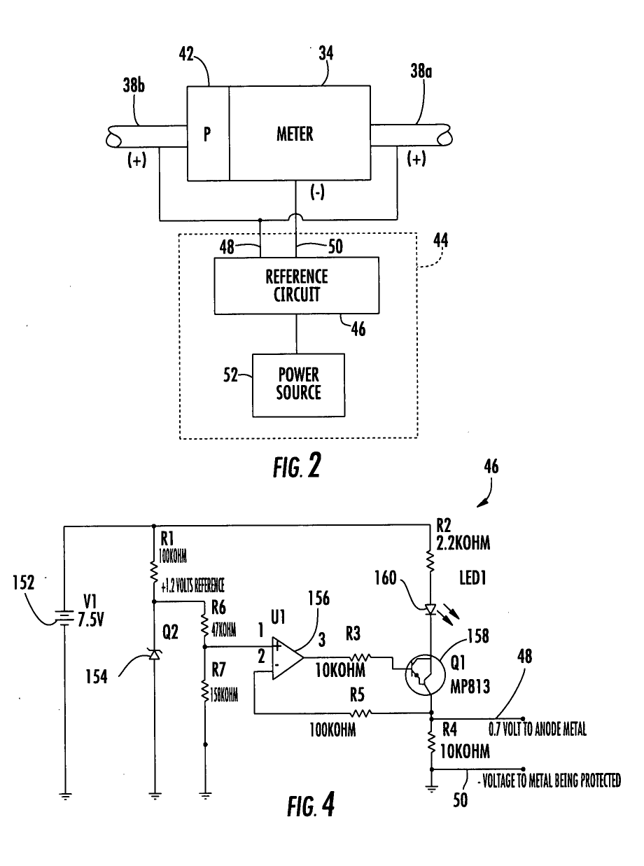

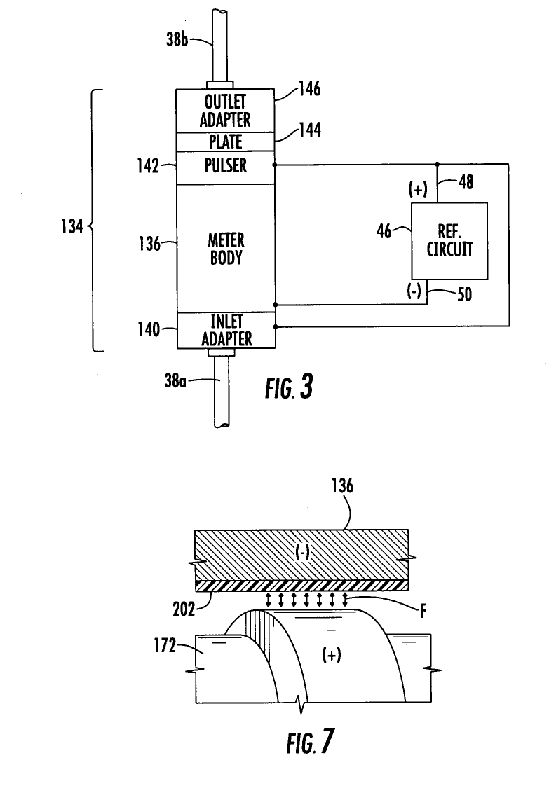

FIG. 4 is a schematic diagram of an exemplary embodiment of reference circuit 46. As shown, a power source 152 supplies 7.5 volts DC to a voltage divider network. In this case, a zener diode (Q2) 154 gives a known voltage at the junction of resistors R1 and R6. The junction of resistors R6 and R7 provides the reference voltage to the positive input of an operational amplifier (U1) 156. Positive terminal 48 is fed back to the negative input of amplifier 156 through resistor R5. Amplifier 156 thus controls transistor (Q1) 158 in order to maintain the desired reference voltage at positive terminal 48, in this case 0.7V (yielding a relative −0.7V from between negative to positive terminals). Light emitting diode 160, which may be red or another suitable color, provides a visual indication that current is flowing. The brightness of the LED is indicative of the current's intensity.

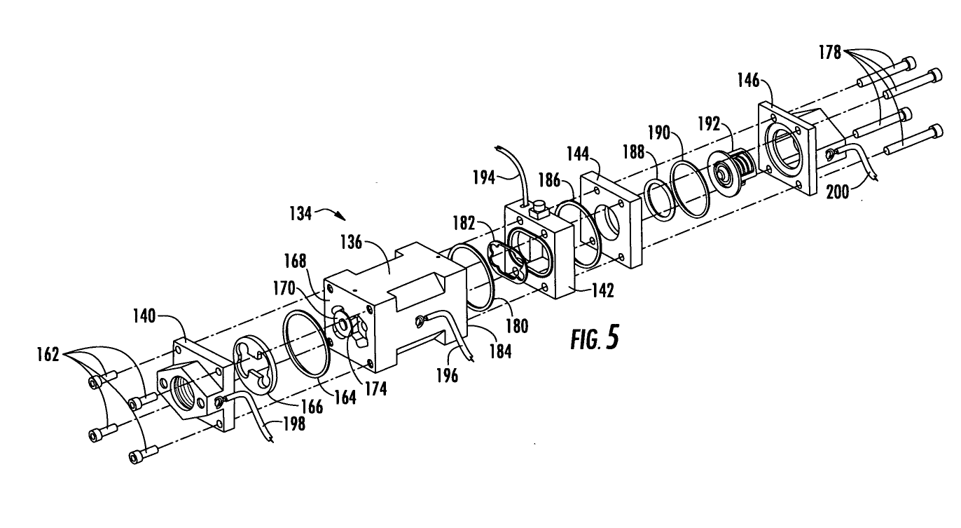

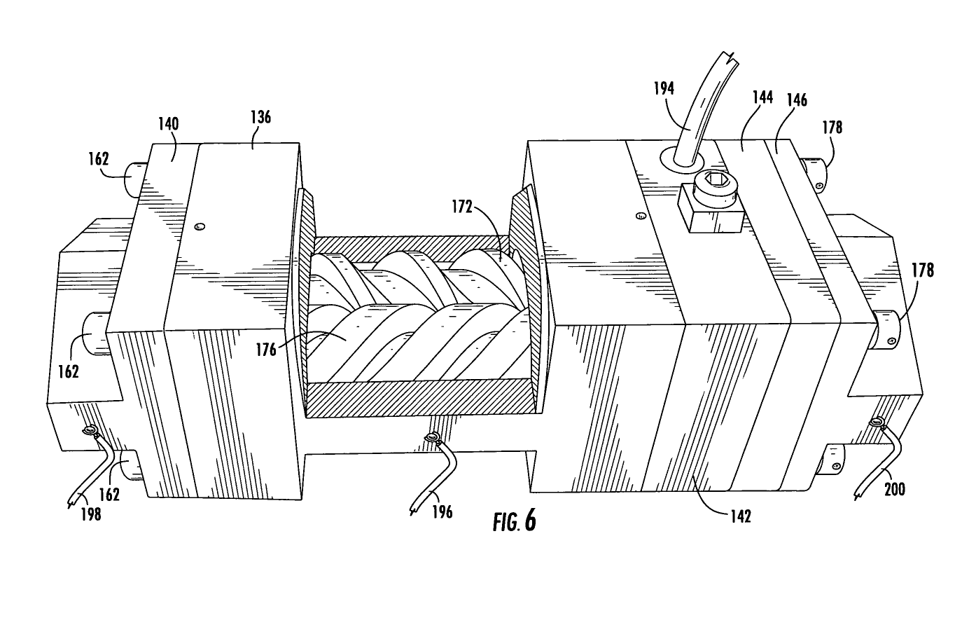

Various details regarding the construction of meter 134 can be most easily described with reference to FIGS. 5 and 6. As shown, inlet adapter 140 is attached to meter body 136 using a plurality of attachment screws 162. An O-ring seal 164 is located between meter body 136 and inlet adapter 140. In addition, inlet adapter 140 positions a bearing retainer disc 166 against the end face 168 of meter body 136. Retainer disc 166 engages a bearing 170 that rotatably supports a first screw spindle 172. Bearing 174, which rotatably supports second screw spindle 176, is axially offset from bearing 170 as shown.

At the other end of meter body 136, pulser 142, discharge plate 144 and outlet adapter 146 are attached via a plurality of attachment screws 178. An O-ring 180 and bearing retainer disc 182 are captured between pulser 142 and the end face 184 of meter body 136. Similarly, an O-ring 186 is located between pulser 142 and discharge plate 144. O-rings 188 and 190 are located between discharge plate 144 and outlet adapter 146. In addition, a check valve assembly 192 is retained in outlet adapter 146. The signal output for pulser 142 is provided at line 194. Embodiments are contemplated in which discharge plate 144 is omitted. Moreover, as one skilled in the art will recognize, screws 162 and 178 are preferably made nonconductive or are otherwise configured to prevent electrical connection between the electrically isolated parts. For example, respective sleeve insulators may be used to insulate the screws.

Unlike previous twin spindle flow meters, flow meter 134 further includes terminal connections 196, 198 and 200 at meter body 136, inlet adapter 140 and outlet adapter 146, respectively. In this case, terminal connections 196, 198 and 200 may be configured as lead wires that are attached to the desired location utilizing a terminal screw (or any other suitable means of attachment). Negative terminal 50 of reference circuit 46 is connected via 196, whereas positive terminal 48 is connected via 198 and 200. It will often be desirable to coat the external negative and positive component terminal connections with an insulator (such as paint or solid film) to inhibit the formation of atmospheric terminal oxidation.

In an additional embodiment of the present invention, positive terminal 48 of reference circuit 46 may be connected to the spindles located within meter body 136. As can be seen in FIG. 7, this creates a relatively uniform electric field (as indicated by the letter “F”) along the entire axial length of meter body 136. As a result, a more uniform current density can be achieved over the protected portion. This can be accomplished by allowing bearing plates 166 and 182 to be in electrical communication with positive terminal 48. Bearing plates 166 and 182 contact the bearings supporting the screw spindles, thus allowing electrical communication with the screw spindles themselves.

FIG. 7 also shows a barrier coat 202 located on the inside surface of meter body 136. In many preferred embodiments, barrier coat 202 may be formed of a silicone material, or other suitable organic or inorganic material. Oftentimes, the nominal clearance between the outermost portion of the screw spindle and the inside surface of meter body 136 may be about 10 microns.

It can thus be seen that the present invention provides an apparatus for use in a fuel dispensing environment having a novel internal surface corrosion protection arrangement. Preferably, the invention eliminates the galvanic potential for corrosion to form on specific dispensing components and assemblies when exposed to various liquid and/or gaseous fuels (and additives). A negative direct current from the reference circuit operates to suppress an oxide reaction on the protected internal portion. While a fuel dispenser was shown in the above example, principles of the invention may be utilized with an additive dispenser as well.

While preferred embodiments of the invention have been shown and described, modifications and variations may be made thereto by those of ordinary skill in the art without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to be limitative of the invention as further described in the appended claims.

What is claimed is:

1. A fuel dispensing apparatus comprising:
a flow conduit defining a fluid flow path;
a plurality of fuel handling components connected along said flow conduit, said fuel handling components including a fluid meter to measure quantity of fuel being dispensed and at least one valve to vary flow of said fuel through said flow conduit; and
a corrosion protection arrangement in electrical communication with at least one of said fuel handling components, said corrosion protection arrangement operative to inhibit formation of corrosion at a protected portion internal to said fuel handling component due to electrical current passing through liquid therein.

2. A fuel dispensing apparatus as set forth in claim 1, wherein said corrosion protection arrangement impresses a relative negative potential between said protected portion and at least one other location along said fluid flow path.

3. A fuel dispensing apparatus as set forth in claim 2, wherein said relative negative potential falls in a range of approximately −0.3 to −0.7 volts.

4. A fuel dispensing apparatus as set forth in claim 2, wherein said at least one other location includes a first location upstream of said protected portion and a second location downstream of said protected portion along said flow path.

5. A fuel dispensing apparatus as set forth in claim 2, wherein said protected portion includes at least one internal surface of a body of said fluid meter.

6. A fuel dispensing arrangement as set forth in claim 5, wherein said at least one other location is coaxial with said internal surface of said body of said fluid meter.

7. A fuel dispensing arrangement as set forth in claim 5, wherein said fluid meter has at least one screw spindle, said corrosion protection arrangement impressing said relative negative potential between said internal surface of said body and said spindle.

8. A fuel dispensing apparatus as set forth in claim 5, wherein said at least one other location includes an inlet adapter of said fluid meter.

9. A fuel dispensing apparatus as set forth in claim 5, wherein said at least one other location includes a pulser of said fluid meter.

10. A fuel dispensing apparatus as set forth in claim 1, wherein said corrosion protection arrangement includes a reference circuit providing a selected DC potential to said protected portion.

11. A fuel dispensing apparatus as set forth in claim 1, wherein said corrosion protection arrangement is in electrical communication with said fluid meter.

12. A fuel dispensing apparatus as set forth in claim 11, wherein said corrosion protection arrangement is in electrical communication with said valve.

13. A fuel dispensing apparatus as set forth in claim 12, wherein said plurality of fuel handling components include a shear valve and said corrosion protection arrangement is in electrical communication with said shear valve.

14. A fuel dispensing apparatus as set forth in claim 1, wherein said plurality of fuel handling components include a shear valve.

15. A fluid meter comprising:
a body defining a fluid flow path;
at least one spindle located in said body along said fluid flow path;
said spindle being adapted to rotate as fluid passes through said body;
a pickup operative to detect rotation of said spindle and generate a signal indicative of said rotation; and
a corrosion protection arrangement in electrical communication with said body to impress a relative negative potential so as to inhibit formation of corrosion therein.

16. A fluid meter as set forth in claim 15, wherein said relative negative potential falls in a range of approximately −0.3 to −0.7 volts.

17. A fluid meter as set forth in claim 16, wherein said corrosion protection arrangement includes a reference circuit providing a selected DC negative potential to said protected area.

18. A fluid meter as set forth in claim 16, further comprising:
an inlet adapter located at a first axial end of said body, said inlet adapter being electrically isolated from said body; and
wherein said corrosion protection arrangement impresses a relative positive potential at said inlet adapter.

19. A fluid meter as set forth in claim 18, wherein said pickup comprises a pulser located at a second axial end of said body.

20. A fluid meter as set forth in claim 19, wherein said corrosion protection arrangement impresses a relative positive potential at said pulser.

21. A fluid meter as set forth in claim 15, wherein said corrosion protection arrangement impresses a relative positive potential at said spindle.

22. A fluid meter as set forth in claim 15, wherein said at least one spindle comprises a pair of screw spindles.

23. A method of protecting from corrosion an internal portion of a fluid meter connected along a flow conduit, said method comprising steps of:
(a) providing a reference circuit adapted to produce a selected DC potential between first and second terminals, said first terminal being connected to a body of said fluid meter and said second terminal being connected to a second location electrically isolated therefrom;
(b) causing liquid to pass through said flow conduit; and
(c) while said liquid is passing through said flow conduit, impressing said DC potential between said fluid meter body and said second location such that current flows through said liquid so as to provide cathodic corrosion protection at said internal portion to be protected.

24. A method as set forth in claim 23, wherein said second location is a spindle of said fluid meter.

25. Apparatus for dispensing a liquid, said apparatus comprising:
a flow conduit defining a fluid flow path for liquid;
a plurality of liquid handling components connected along said flow conduit;
a corrosion protection arrangement in electrical communication with at least one of said liquid handling components; and
said corrosion protection arrangement operative to inhibit formation of corrosion at a protected portion internal to said liquid handling component due to electrical current passing through said liquid therein.
